(19) United States
(12) Patent Application Publication
(10) Pub. No.: US 2026/0119409 A1
(43) Pub. Date: Apr. 30, 2026

(54) Efficient Address Translation Cache Invalidation in Data Storage Devices

(71) Applicant: Sandisk Technologies, Inc., Milpitas, CA (US)

(72) Inventors: Shay BENISTY, Beer Sheva (IL); Amir SEGEV, Meiter (IL)

(73) Assignee: Sandisk Technologies, Inc., Milpitas, CA (US)

(21) Appl. No.: 18/933,321

(22) Filed: Oct. 31, 2024

(51) Int. Cl. G06F 12/1045; G06F 12/0808

(52) U.S. Cl. CPC G06F 12/1045; G06F 12/0808

(57) ABSTRACT

Rather than clearing out an entire address translation cache (ATC) upon receiving an invalidation request, a data storage device can focus on any individual untranslated addresses found in the invalidation request. The data storage device can, immediately upon receipt of the invalidation request, request translation of the untranslated address from a translation agent (TA). In response, the TA will provide a translated address. The data storage device can then compare translated addresses in the ATC to the translated address received from the TA. The data storage device can then complete any relevant commands associated with the untranslated address, flush the translated address and the untranslated address, and issue an invalidation completion. The total invalidation flow can be completed in less than 1 millisecond without clearing the entire ATC.

### BACKGROUND OF THE DISCLOSURE

### Field of the Disclosure

Embodiments of the present disclosure generally relate to improved address translation cache (ATC) invalidation.

### Description of the Related Art

One of the use cases of a multi-tenancy device is where the solid-state drive (SSD) is shared across multiple tenants (i.e., virtual memories (VMs)) without any hypervisor layer between the SSD and the VM. There are a variety of optimizations around memory usage that will be done when the host operating system (OS) (e.g. Windows Server) implements page movement capabilities. The capabilities require address translation service (ATS) and Page Request Interface (PRI) functionality in any peripheral component interconnect express (PCIe) device that is directly accessed by guest VMs. Moving memory pages implies the device will receive PCIe addresses that need to be translated.

ATS is a feature that when a host device does not provide the physical addresses, but instead provides virtual addresses, and before using those virtual addresses, a translation is needed. In order to translate those virtual addresses, the device controller interacts with a translation agent (TA). The device controller provides the untranslated address to the TA and asks for translation service. The response will be a translated address associated with the specific untranslated address. In order to minimize the overhead in the system and the many packets that need to transfer over the interface, the device controller may implement address translation cache (ATC). The ATC is useful because in the future, there might be the same untranslated address that needs translating and instead of sending immediately to the TA in order to get the translated address, the ATC is checked to see whether the translation is present. If the translation is present, the extra overhead on the interface is avoided. When the ATC is used, all the addresses in the system, including the submission queues, completion queues, pointers, PRPs, SGLs, etc. will use the ATC.

There is also a feature called invalidation. In invalidation, the TA may ask the data storage device to remove something from the cache. The TA will tell the SSD to take certain untranslated address and remove those untranslated address from cache because the translated address associated with the untranslated address has been modified. If the untranslated address is in the cache, the untranslated address will be removed and the response will be a completion to the TA indicating that the untranslated address has been removed from the cache. Thus, the translated address for the untranslated address is not allowed to be used. If the untranslated address is received again, the SSD will need to ask for the translation service again before using the address. Such operation is inefficient.

Therefore, there is a need in the art for improved address translation invalidation.

### SUMMARY OF THE DISCLOSURE

Rather than clearing out an entire address translation cache (ATC) upon receiving an invalidation request, a data storage device can focus on any individual untranslated addresses found in the invalidation request. The data storage device can, immediately upon receipt of the invalidation request, request translation of the untranslated address from a translation agent (TA). In response, the TA will provide a translated address. The data storage device can then compare translated addresses in the ATC to the translated address received from the TA. The data storage device can then complete any relevant commands associated with the untranslated address, flush the translated address and the untranslated address, and issue an invalidation completion. The total invalidation flow can be completed in less than 1 millisecond without clearing the entire ATC.

In one embodiment, a data storage device comprises: a memory device; and a controller coupled to the memory device, wherein the controller is configured to: receive an invalidation request, wherein the invalidation request includes one or more untranslated addresses; issue an address translation request for the one or more untranslated addresses; receive a translated address for each untranslated address of the one or more untranslated addresses; and determine whether the translated address matches a stored translated address.

In another embodiment, a data storage device comprises: a memory device; and a controller coupled to the memory device, wherein the controller is configured to: receive an invalidation request from a host device, wherein the invalidation request includes an untranslated address; determine that an ATC does not contain the untranslated address; determine that the ATC contains one or more translated addresses; request a translation of the untranslated address; and receive a translated address of the untranslated address.

In another embodiment, a data storage device comprises: means to store data; and a controller coupled to the means to store data, wherein the controller is configured to: avoid clearing an entire ATC upon receiving an invalidation request; and completing the invalidation request in less than 1 millisecond.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic diagram illustrating a multi-tenancy system supporting ATS functionality, according to certain embodiments.

FIG. 3 is a schematic diagram illustrating an address translation cache (ATC) invalidation protocol with a single request and completion according to one embodiment.

FIG. 4 is a schematic illustration of commands in flight in a data storage device according to one embodiment.

FIG. 5 is a flowchart illustrating an ATC invalidation flow according to one embodiment.

FIG. 6 is a flowchart illustrating an ATC invalidation flow according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Rather than clearing out an entire address translation cache (ATC) upon receiving an invalidation request, a data storage device can focus on any individual untranslated addresses found in the invalidation request. The data storage device can, immediately upon receipt of the invalidation request, request translation of the untranslated address from a translation agent (TA). In response, the TA will provide a translated address. The data storage device can then compare translated addresses in the ATC to the translated address received from the TA. The data storage device can then complete any relevant commands associated with the untranslated address, flush the translated address and the untranslated address, and issue an invalidation completion. The total invalidation flow can be completed in less than 1 millisecond without clearing the entire ATC.

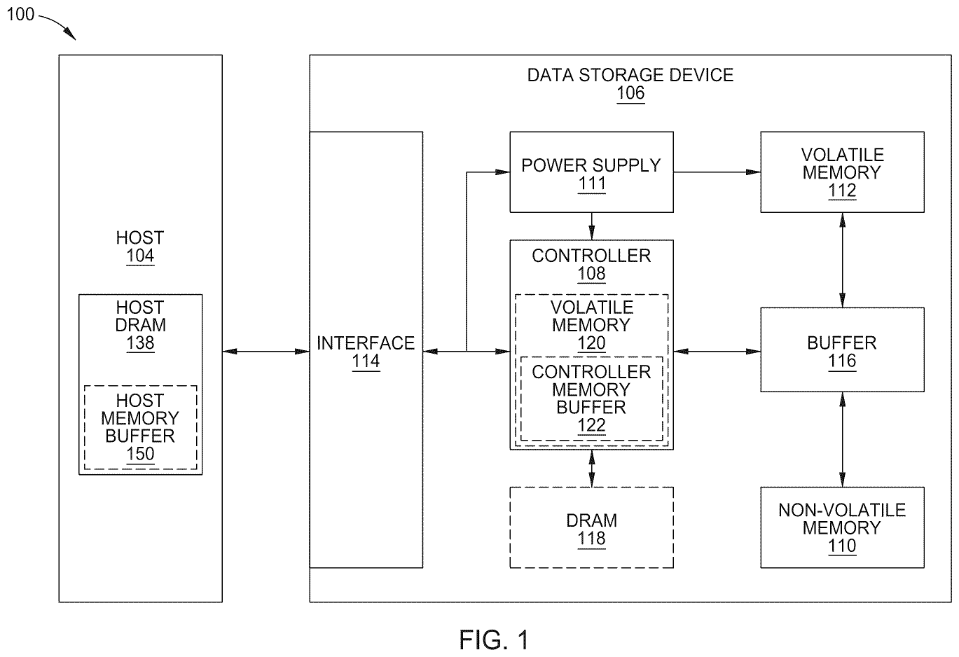

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

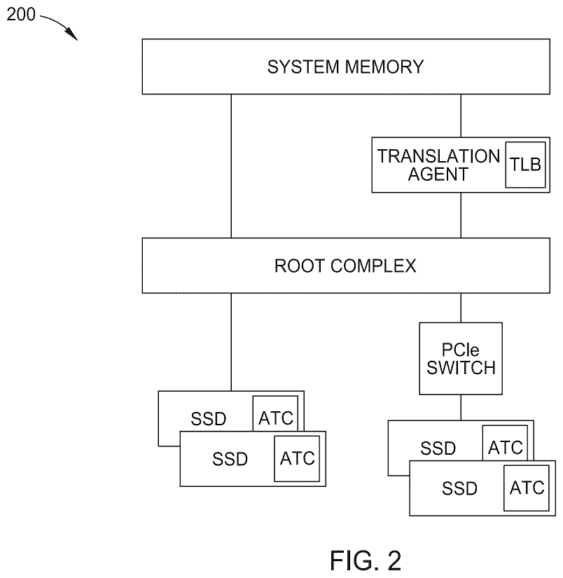

FIG. 2 is a schematic diagram illustrating a multi-tenancy system 200 supporting ATS functionality, according to certain embodiments. A TA services memory translation requests within the TA. Within the TA, the ATC is referred to as a translation look-aside buffer (TLB). When the ATS enabled SSD device accesses system memory, the SSD shall cache translated addresses in an internal ATC. The ATC is different from the TLB translation cache used by the host device. When the ATS enabled SSD device shall implement and maintain a designated ATC to minimize performance dependencies on the TA and alleviate TA resource pressure.

Examples of PCIe addresses to be translated include: caching of submission queue (SQ) and completion queue (CQ) address ranges; SQ entry decoding including standard decoding of the data pointer for read or write that submit translation requests immediately, PRPs and SGLs that decode the data pointers and follow linked lists and upper bound of translations per large commands equal a rate match PRI translations with Gen5 bandwidth (BW) maximums, and DIX translation requests for metadata pointers and associated linked lists of addresses.

When a TA determines that a function should no longer maintain a translation with an ATC, the TA initiates the ATS invalidation protocol. The invalidation protocol consists of a single invalidation request and one or more invalidation completions. As will be discussed herein, the disclosure tackles the challenge of implementing the ATC invalidation flow, which is a complex process where the data storage device pauses and locates relevant untranslated addresses within the device. The disclosure provides a streamlined approach to the intricate flow.

Previously, data storage devices would evict the entire ATC to avoid the complex lookup operation. Evicting the entire ATC is a simple flow, but is sub-optimal as the entire cache is deleted even though only a single entry should be deleted. The simple approach will delete everything and start everything from the beginning, but such is not efficient because everything was removed while the host device just asks for removing one entry from the cache.

Another approach is to implement a complex lookup operation in the data storage device. When implementing the lookup operation, some entries already hold translated addresses, but not an untranslated address. For those commands, the device controller will have to complete the commands before sending the completion for the invalidation request as the untranslated address is unknown to the device controller at that point in time. Again, a sub-optimal flow since the flow takes a lot of time to complete the invalidation request. The approach involves scanning the cache and finding the exact entry that should be removed and then removing the exact entry. Finding the exact entry will take a lot of time and negatively impact the performance of the controller.

Another issue that occurs when the host device asks for removing an entry from the cache is that the host device provides the untranslated address and in some scenarios, the untranslated address is not stored in the data storage device. The data storage device just has the translated address and thus the data storage device does not know whether there is a match in the cache.

The disclosure introduces an idea for simplifying the ATC invalidation flow while meeting customer requirements. The new flow involves: avoiding the need to clear the entire ATC due to invalidate requests; and ensuring completion of the invalidation request in less than 1 millisecond.

One significant challenge in implementing the invalidation flow is that the data storage device only receives untranslated addresses for deletion, lacking the corresponding translated addresses. As noted above, some entries have already undergone translation, and the device controller does not retain the untranslated addresses after receiving the corresponding translated address.

The proposed solution involves the data storage device immediately issuing an address translation request for the untranslated address that is in an invalidation request upon receiving the invalidation request. Consequently, the device controller obtains the translated address version, simplifying the invalidation process. Such a streamlined approach enables the device controller to swiftly complete the request without the need to wait for the completion of unrelated host commands.

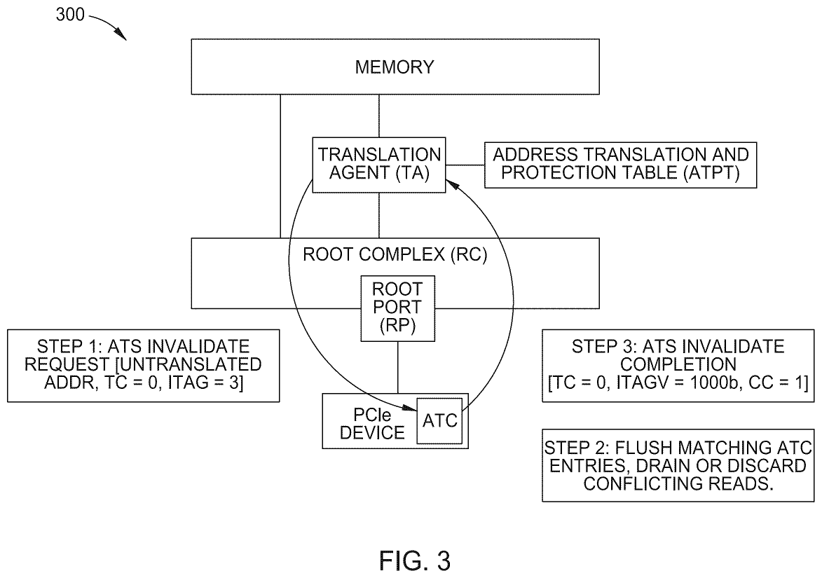

When a TA determines that a function should no longer maintain a translation within an ATC, the TA initiates the ATS invalidation protocol. The invalidation protocol consists of a single invalidation request and one or more invalidate completions. FIG. 3 is a schematic diagram 300 illustrating an ATC invalidation protocol with a single request and completion according to one embodiment. FIG. 3 illustrates, there are essentially three steps in the ATC Invalidation protocol.

The first step is the system software updates an entry in the tables used by the TA. After the table is changed, the TA determines that a translation should be invalidated in an ATC and initiates an invalidation request TLP which is transmitted from the root port (RP) to the example single-function device. The invalidate request communicates an untranslated address range, the traffic class (TC), and an RP unique tag which is used to correlate invalidate completions with the invalidation request. TC is a mechanism used to prioritize and manage the flow of data between devices and are primarily used to ensure that certain types of traffic, such as high priority or time sensitive data are given preferential treatment over lower priority traffic. The prioritization helps optimize performance in environments where multiple devices and data streams are sharing the same PCIe link.

The second step is for the function to receive the invalidation request and invalidate all matching ATC entries. A function is not required to immediately flush all pending requests upon receipt of an invalidation request. If transactions are in a queue waiting to be sent, it is not necessary for the function to expunge requests from the queue even if those transactions use an address that is being invalidated. A function is required not to indicate the invalidation has completed until all outstanding read requests or translation requests that reference the associated translated address have been retired or nullified. A function is required to ensure that the invalidation completion indication to the root complex (RC) will arrive at the RC after any previously posted writes that use the “stale” address.

The third step involves after a function has ascertained that all uses of the translated address are complete, the controller issues one or more ATC invalidate completions.

Stated another way, the TA sends an invalidation request to the SSD along with an untranslated address. The SSD needs to flush the matching entry from the cache if the cache has a match. After removing the matching entry from the cache, the controller will send a completion to the TA indicating that the matching entry was removed from the ATC.

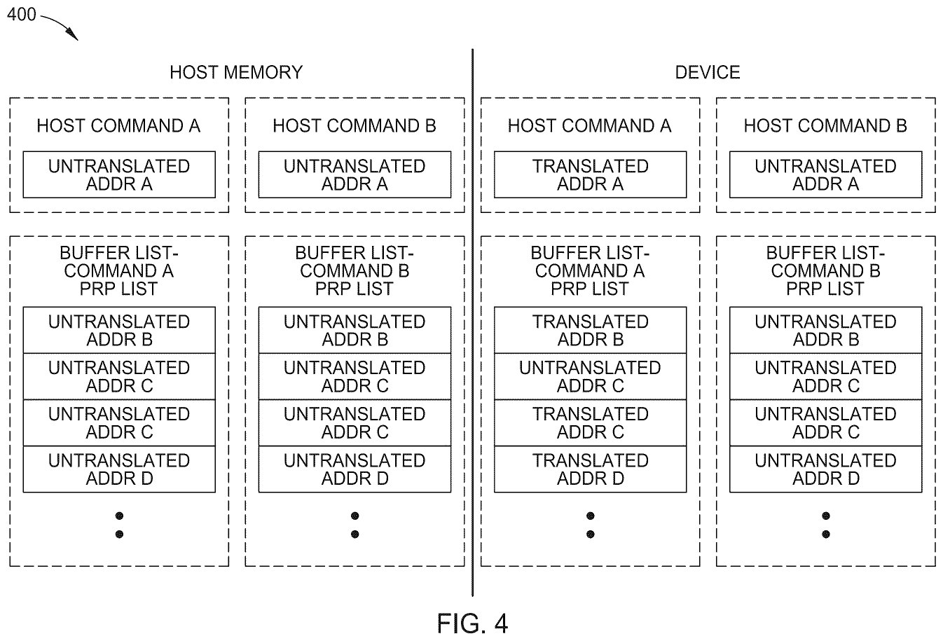

FIG. 4 is a schematic illustration 400 of commands in flight in a data storage device according to one embodiment. FIG. 4 illustrates the commands and the relevant pointers as being held in the host device and data storage device sides. In the host device side, the commands and the pointers are in the untranslated formats. The device controller fetches the commands and the pointers and translates the commands and pointers as needed as part of the execution phase. There might be a scenario that for one command, some of the pointers are translated and some are not since the data storage device still did not do that. For the translated addresses, the data storage device may have already deleted the untranslated values.

The behavior introduces the challenge when executing the invalidation request. As part of the invalidation request, the host device provides the untranslated address which could be good enough for the lookup operation for the pointers that are not yet translated. However, for the pointers that were already translated by the device controller, the untranslated version is not maintained in the data storage device anymore. The device controller will have to wait for the completion of commands associated with the translated addresses before completing the invalidation request. The behavior adds extra latency for the execution of the invalidation request.

Stated another way regarding FIG. 4, FIG. 4 shows what will happen eventually with the pointers that are in the host device and in the data storage device. In the host memory, there are untranslated addresses. The host memory contains only untranslated addresses and those untranslated addresses are the logical addresses. The data storage device is not allowed to use the untranslated addresses. Before using the untranslated addresses, the data storage device will need to translate the untranslated addresses. In one scenario, what eventually will happen in the data storage device is, the data storage device fetches host command A. In host command A there is the untranslated address. The data storage device will then interact with the TA in order to get the translated address for the untranslated address and then keep the translated address internally. It is to be kept in mind that the data storage device in this example does not keep the untranslated address after the translation has occurred. The data storage device only keeps the translated address. Then when the host device sends the device invalidation request, the host device provides the untranslated address. The data storage device, which did not maintain the untranslated address, does not know what to flush from the cache. The data storage device does not know which translated address is related to the untranslated address of the invalidation request. The data storage device does not know which translated address cannot be used anymore. Thus, there is extra complexity in the data storage device side.

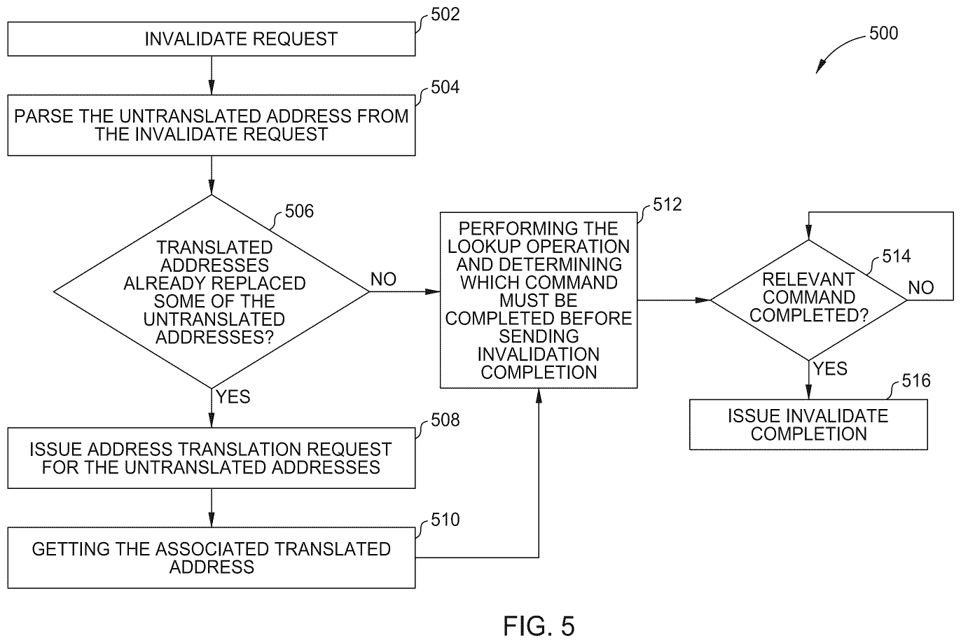

FIG. 5 is a flowchart 500 illustrating an ATC invalidation flow according to one embodiment. The device controller gets the ATC invalidation request with the relevant untranslated address. If there are addresses that have already been translated and the untranslated version is not maintained in the data storage device, the data storage device just sends an ATS address translation request to the TA with the relevant untranslated address. As a response, the data storage device gets the translated version of it. Now, the lookup operation is simpler since device controller has both untranslated and translated addresses. The data storage device can easily determine the commands (or part of the commands) that must be completed, waits for the completion, and sends the completion for the invalidation request.

More specifically in regards to FIG. 5, after having the translated address and not keeping internally the untranslated address A, the data storage device gets the invalidation request for the untranslated address and needs to handle the situation. The data storage device will immediately send the untranslated address to the TA, and the TA will respond back with the translated address. Now the data storage device has the translated version of the untranslated address, and the data storage device can compare the translated address maintained in the ATC and the translated address delivered from the TA. The comparison is against the translated address that was kept internally because again, the problem is that there is no untranslated address A maintained in the data storage device. Only the translated address was maintained.

Therefore, immediately after receiving the ATC invalidation request with the untranslated address, the data storage device is going to ask the TA for the associated address with the untranslated address. The TA will then respond back with the translated address that is to be removed from the cache. The data storage device can then compare the translated address from the TA to the translated address in the ATC and know whether there is something that cannot be used in the cache. The device controller will know immediately and thus the flow is simplified without the need to even store the untranslated address internally in the data storage device.

Referring to the flowchart specifically, the proposed ATC invalidation flow involves receiving the invalidation request at block 502 for one or more untranslated addresses that are then parsed at block 504. The data storage device checks to see whether any translated addresses have already replaced some of the untranslated addresses at block 506. If no for block 506, then the lookup can occur immediately at block 512 by performing the lookup operation and determining which command must be completed before sending the invalidation completion. If yes for block 506, then there will be extra steps. The data storage device will interact with the TA at block 508 by issuing a translation request for the untranslated address(es) and then getting the associated translated address(es) from the TA at block 510. The process then proceeds to block 512 followed by a determination at block 514 of whether the relevant command has been completed. If the command has not been completed, then the data storage device waits for the command to be completed, but if the command has been completed, then the data storage device issues the invalidation completion at block 516.

In one embodiment, the device just waits for the data-transfer completion for the relevant addresses while in other embodiment, it waits for the entire command completion.

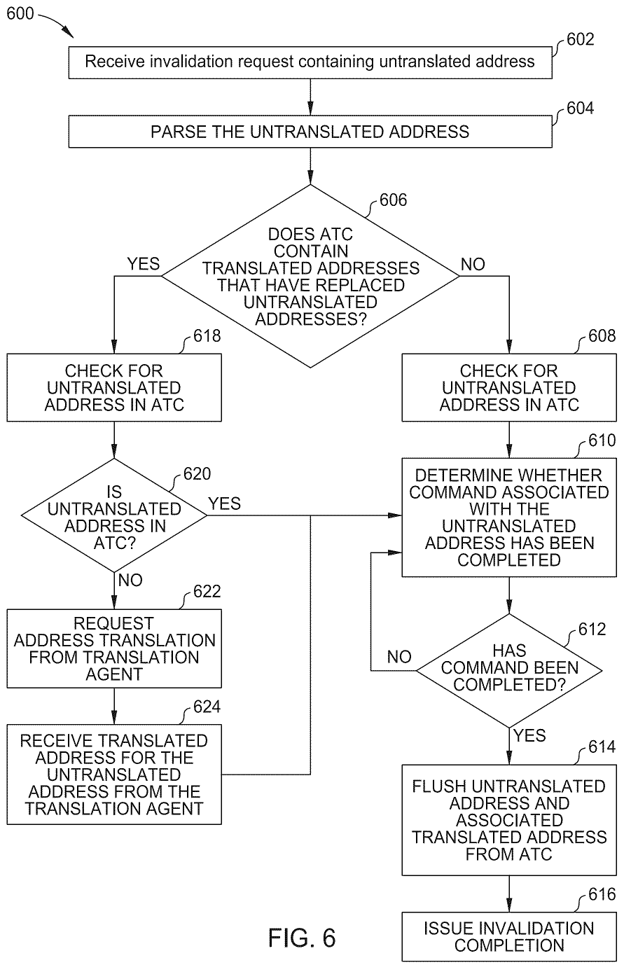

FIG. 6 is a flowchart 600 illustrating an ATC invalidation flow according to one embodiment. Initially, an invalidation request containing an untranslated address is received at block 602, and the untranslated address is parsed at block 604. The controller determines whether the ATC contains translated address that have replaced untranslated addressees at block 606. If there are no translated addresses that have replaced untranslated addresses at block 606, then the ATC is checked for the untranslated address at block 608 followed by a determination of whether the command associated with the untranslated address have been completed at block 610. If the command has not been completed at block 610, then the termination is made again as the controller waits at block 612, but if the command has been completed, then the untranslated address and an associated translated address are flushed from the ATC at block 614 followed by issuing an invalidation completion at block 616.

If there are translated addresses that have replaced untranslated addresses in the ATC at block 606, then the ATC is checked for the untranslated address at block 618. If the untranslated address is in the ATC at block 620, then the process continues at block 610, but if the untranslated address is not in the ATC at block 620, then the controller requests address translation from the TA at block 622 followed by receiving the translated address for the untranslated address from the TA at block 624. The process then proceeds to block 610.

By having a simple ATC invalidation flow while meeting customer expectations, there is a benefit of avoiding the need to clear the entire ATC due to invalidation requests, and ensuring completion of the invalidation request in less than 1 millisecond. The streamlined approach disclosed herein enables the device controller to swiftly complete the request without the need to wait for the completion of unrelated host device commands.

In one embodiment, a data storage device comprises: a memory device; and a controller coupled to the memory device, wherein the controller is configured to: receive an invalidation request, wherein the invalidation request includes one or more untranslated addresses; issue an address translation request for the one or more untranslated addresses; receive a translated address for each untranslated address of the one or more untranslated addresses; and determine whether the translated address matches a stored translated address. The stored translated address is stored in an ATC. The address translation request is issued to a TA. The controller is configured to perform a lookup operation and determine which command is to be completed before sending an invalidation completion. The controller is configured to issue the invalidation completion upon completing the command. The issuing, receiving, and determining occurs prior to issuing an invalidation completion for the invalidation request. The controller is configured to wait for data transfer completion for the untranslated address before issuing the invalidation completion. The controller is configured to wait for an entire command containing the untranslated address to complete before issuing the invalidation completion. Prior to the issuing, the controller is configured to determine whether translated addresses have replaced at least one untranslated address in an ATC. Completion of the invalidation request occurs in less than 1 millisecond.

In another embodiment, a data storage device comprises: a memory device; and a controller coupled to the memory device, wherein the controller is configured to: receive an invalidation request from a host device, wherein the invalidation request includes an untranslated address; determine that an ATC does not contain the untranslated address; determine that the ATC contains one or more translated addresses; request a translation of the untranslated address; and receive a translated address of the untranslated address. The controller is configured to perform a lookup operation to compare the translated address to the one or more translated addresses in the ATC. The controller is configured to determine that there is a match between the translated address and a first translated address of the one or more translated addresses. The controller is configured to flush the first translated address from the ATC. The controller is configured to complete a command corresponding to the translated address. The controller is configured to issue an invalidation complete after completing the command. The invalidation complete occurs after flushing the translated address from the ATC.

In another embodiment, a data storage device comprises: means to store data; and a controller coupled to the means to store data, wherein the controller is configured to: avoid clearing an entire ATC upon receiving an invalidation request; and completing the invalidation request in less than 1 millisecond. The controller is configured to issue an address translation request for an untranslated address in the invalidation request. The controller is configured to compare a translated address received due to the address translation request to another translated address disposed in the ATC.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
receive an invalidation request, wherein the invalidation request includes one or more untranslated addresses;
issue an address translation request for the one or more untranslated addresses;
receive a translated address for each untranslated address of the one or more untranslated addresses; and
determine whether the translated address matches a stored translated address.

2. The data storage device of claim 1, wherein the stored translated address is stored in an address translation cache (ATC).

3. The data storage device of claim 1, wherein the address translation request is issued to a translation agent (TA).

4. The data storage device of claim 1, wherein the controller is configured to perform a lookup operation and determine which command is to be completed before sending an invalidation completion.

5. The data storage device of claim 4, wherein the controller is configured to issue the invalidation completion upon completing the command.

6. The data storage device of claim 1, wherein the issuing, receiving, and determining occurs prior to issuing an invalidation completion for the invalidation request.

7. The data storage device of claim 6, wherein the controller is configured to wait for data transfer completion for the untranslated address before issuing the invalidation completion.

8. The data storage device of claim 6, wherein the controller is configured to wait for an entire command containing the untranslated address to complete before issuing the invalidation completion.

9. The data storage device of claim 1, wherein prior to the issuing, the controller is configured to determine whether translated addresses have replaced at least one untranslated address in an address translation cache (ATC).

10. The data storage device of claim 1, wherein completion of the invalidation request occurs in less than 1 millisecond.

11. A data storage device, comprising:
a memory device; and
a controller coupled to the memory device, wherein the controller is configured to:
receive an invalidation request from a host device, wherein the invalidation request includes an untranslated address;
determine that an address translation cache (ATC) does not contain the untranslated address;
determine that the ATC contains one or more translated addresses;
request a translation of the untranslated address; and
receive a translated address of the untranslated address.

12. The data storage device of claim 11, wherein the controller is configured to perform a lookup operation to compare the translated address to the one or more translated addresses in the ATC.

13. The data storage device of claim 12, wherein the controller is configured to determine that there is a match between the translated address and a first translated address of the one or more translated addresses.

14. The data storage device of claim 13, wherein the controller is configured to flush the first translated address from the ATC.

15. The data storage device of claim 11, wherein the controller is configured to complete a command corresponding to the translated address.

16. The data storage device of claim 15, wherein the controller is configured to issue an invalidation complete after completing the command.

17. The data storage device of claim 16, wherein the invalidation complete occurs after flushing the translated address from the ATC.

18. A data storage device, comprising:
means to store data; and
a controller coupled to the means to store data, wherein the controller is configured to:
avoid clearing an entire address translation cache (ATC) upon receiving an invalidation request; and
completing the invalidation request in less than 1 millisecond.

19. The data storage device of claim 18, wherein the controller is configured to issue an address translation request for an untranslated address in the invalidation request.

20. The data storage device of claim 19, wherein the controller is configured to compare a translated address received due to the address translation request to another translated address disposed in the ATC.
